(19) United States
(12) Patent Application Publication
(10) Pub. No.: US 2008/0016733 A1
(43) Pub. Date: Jan. 24, 2008

(54) Indoor and outdoor decorative device

(76) Inventor: Teruhisa Tamamori, Kusatsu-shi (JP)

Correspondence Address: MILDE & HOFFBERG, LLP, 10 BANK STREET, SUITE 460, WHITE PLAINS, NY, 10606, US

(21) Appl. No.: 11/489,660

(22) Filed: Jul. 19, 2006

(51) Int. Cl. G09F 19/00

(52) U.S. Cl. 40/410

(57) ABSTRACT

An indoor and outdoor decorative device 10 for reproducing a state of snowfall using imitation snow 14 of the present invention comprises: a case body 12 which is hollow at least whose front face 31 is transparent; imitation snow lifting means 16 for lifting the imitation snow 14 from the lower portion to the upper portion of the case body 12; and a cover 18 attached to the case body 12, wherein at least the outer circumference 32 of front face of the case body 12 is covered with the cover 18.

### BACKGROUND OF THE INVENTION

1. Field of the Invention

The present invention relates to an indoor and outdoor decorative device which is placed indoor and outdoor.

2. Description of Related Art

Conventionally, indoor decorative devices which are capable of increasing the indoor decorative effect by reproducing a state of snow falling over trees or the like have been used at home and stores or the like. In these indoor decorative devices, granules of foamed plastics are mainly used as imitation snow and the state of snowfall is reproduced by scattering the imitation snow from up above imitation trees and imitation snowmen or the like.

A large number of such indoor decorative devices have been disclosed. The inventor of this invention has suggested an indoor decorative device which is capable of effectively carrying out a cyclic usage of imitation snow and further, an indoor decorative device in which the spouting effect of imitation snow has increased (For example, Patent Cited Documents 1 and 2).

(Patent Cited Document 1) Japanese Utility Model Publication No. 2578022 (claim 1, FIG. 1)

(Patent Cited Document 2) Japanese Patent Publication No. 2003-54199 (claim 1, FIG. 1)

In these indoor decorative devices, it is necessary to cover imitation trees and imitation snowmen or the like to circulatingly use the imitation snow and to prevent the imitation snow from being scattered. Accordingly, a transparent cover enabling the imitation trees or the like to be visible from outside is essential to these indoor decorative devices. However, it is not avoidable for these indoor decorative devices to be divided by this cover and give feeling of oppression to indoor space. Although the cover is transparent, the cover can only reduce feeling of oppression. The transparent cover divides space and somewhat feeling of oppression remains in the indoor space.

Moreover, since all conventional indoor decorative devices were floor typed, it was necessary to secure space for these indoor decorative devices as well as inability of avoiding effects to the afore-mentioned indoor space.

Accordingly, the inventor of this invention has made this invention as a result of repeated examination to provide an indoor and outdoor decorative device capable of continuously reproducing the state of snowfall without any feeling of oppression and presence because of a cover for cyclic use of the imitation snow and preventing snow from being scattered.

### SUMMARY OF THE INVENTION

An indoor and outdoor decorative device according to the present invention comprises: a case body which is hollow at least whose front face is transparent to reproduce a state of snowfall using imitation snow; imitation snow lifting means for lifting the imitation snow from the lower portion to the upper portion of the case body and dropping the imitation snow in the case body; and a cover to be attached to the case body, wherein at least the outer circumference of front face of the case body is covered with the cover.

In the indoor and outdoor decorative device according to the present invention, particularly, the imitation snow lifting means comprises: a tube-shaped member in which an inlet is located in the lower portion of the case body and an outlet is located in the upper portion of the case body; and a blower for blowing the imitation snow from the inlet to the outlet in a piping passage within the tube-shaped member to spout the imitation snow from the outlet into the case body, wherein the blower or the imitation snow lifting means is covered with the cover.

In the indoor and outdoor decorative device according to the present invention, particularly, the tube-shaped member is provided outside the case body and there is continuity between the inside of the case body and the piping passage by the inlet and the outlet.

Further, in the indoor and outdoor decorative device according to the present invention, a guide plate for dispersing the imitation snow to be spouted from the outlet into the case body is provided in the case body adjacent to the outlet.

In the indoor and outdoor decorative device according to the present invention, the imitation snow lifting means comprises: a rotary wheel rotatably arranged in the case body; and a motor for rotating and driving the rotary wheel, wherein a plurality of backing plates for imitation snow tilted from an rotation axis located in center of the rotary wheel toward the direction of rotation are spaced around the circumference of the rotary wheel and the imitation snow is lifted from the lower portion to the upper portion of the case body by the backing plates for imitation snow.

In the indoor and outdoor decorative device according to the present invention, particularly, the adjacent backing plates for imitation snow respectively have a different oblique angle.

In the indoor and outdoor decorative device according to the present invention, a guide plate for dispersing the imitation snow falling from the backing plates for imitation snow into the case body is provided in the upper portion of the case body.

The indoor and outdoor decorative device according to the present invention is capable of continuously reproducing the state of snowfall without giving feeling of oppression and presence in the indoor space more than necessary because a cover is attached to the case body.

Moreover, the indoor and outdoor decorative device according to the present invention has no need to secure installation space because of a wall hanging type.

Furthermore, the indoor and outdoor decorative device according to the present invention is capable of further increasing the decoration effect of the indoor and outdoor by the additional function to reproduce the state of snow-fall in a wall-hanging decoration, such as a conventional Christmas wreath or the like.

### BRIEF DESCRIPTION OF THE DRAWING

FIG. 1 (a) is a front view showing an embodiment of an Indoor and outdoor decorative device of the present invention.

FIG. 1 (b) is an end view of the central section taken from the front of the indoor and outdoor decorative device shown in FIG. 1 (a).

FIG. 1 (c) is an end view of the central section taken from the side of the indoor and outdoor decorative device shown in FIG. 1 (a).

FIG. 2 is an end view of the central section taken from the side showing another embodiment of the indoor and outdoor decorative device of the present invention.

FIG. 3 (a) is an end view of the central section taken from the front showing still further embodiment of the indoor and outdoor decorative device of the present invention.

FIG. 3 (b) is a plan view of a guide plate shown in FIG. 3 (a).

FIG. 3 (c) is a cross-sectional view showing another embodiment of the guide plate of the present invention.

FIG. 3 (d) is a cross-section showing still further embodiment of the guide plate of the present invention.

FIG. 4 (a) is an end view of the central section seen from the side showing further embodiment of the indoor and outdoor decorative device of the present invention.

FIG. 4 (b) is a cross-sectional view taken on section A-A shown in FIG. 4 (a).

FIG. 4 (c) is a cross-sectional view taken on section B-B shown in FIG. 4(b).

FIG. 5 (a) is an end view of the central section seen from the side showing still another embodiment of the indoor and outdoor decorative device of the present invention.

FIG. 5 (b) is a cross-sectional view taken on section C-C (guide plates are omitted) in FIG. 5 (a).

FIG. 6 is an end view of the central section seen from the front showing yet another embodiment of the indoor and outdoor decorative device of the present invention.

FIG. 7 (a) is a front view showing another embodiment of the indoor and outdoor decorative device of the present invention.

FIG. 7 (b) is an end view of the central section seen from the front of the indoor and outdoor decorative device shown in FIG. 7 (a).

FIG. 8 (a) is an end view of the central section seen from the front showing still further embodiment of the indoor and outdoor decorative device of the present invention.

FIG. 8 (b) is an end view taken section D-D shown in FIG. 8 (a) (backing plates for imitation snow are omitted).

FIG. 9 (a) is an end view of the central section seen from the front showing further embodiment of the indoor and outdoor decorative device of the present invention.

FIG. 9 (b) is an end view taken section E-E shown in FIG. 9 (a) (backing plates for imitation snow and a guide plate are omitted).

### DESCRIPTION OF THE PREFERRED EMBODIMENTS

Now, specific embodiments of an indoor and outdoor decorative device according to the present invention will be described in detail with reference to the accompanying drawings.

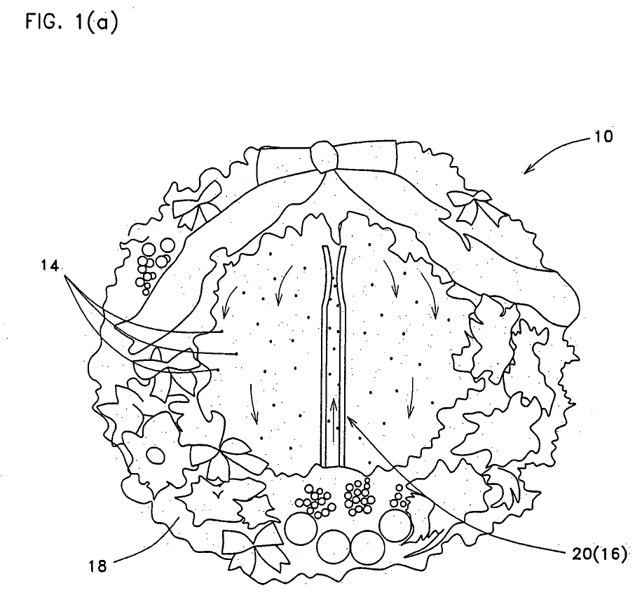

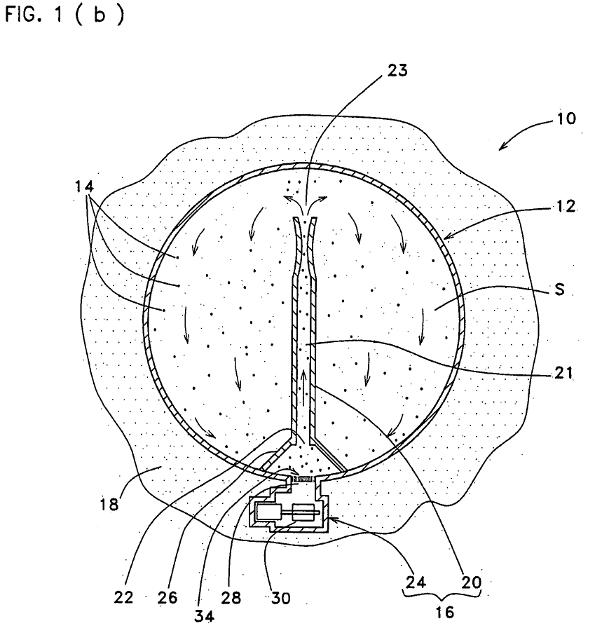

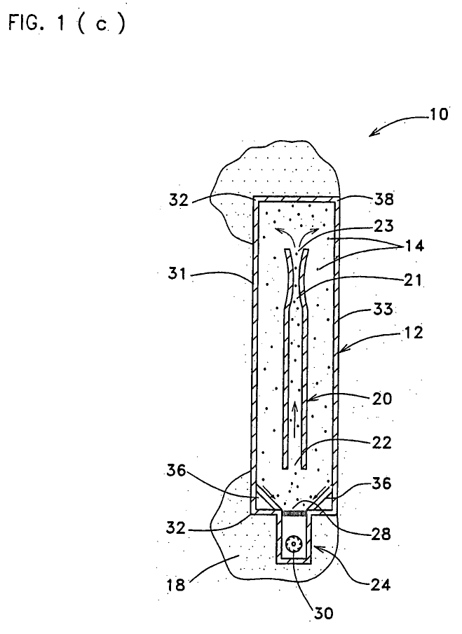

FIGS. 1 (a) to 1 (c) respectively show an embodiment of an indoor and outdoor decorative device of the present invention, such as a wreath device (indoor and outdoor decorative device 10) including a Christmas wreath or the like. The indoor and outdoor decorative device 10 comprises: a case body 12 in a virtually cylindrical form; imitation snow 14 made of foamed resin located in the case body 12; imitation snow lifting means 16 for lifting the imitation snow 14 from the lower portion to the upper portion of the case body 12; and a cover 18 attached to the case body 12. Powders of foamed resin, such as foamed polystyrene are preferably used as imitation snow 14, but the material is not particularly limited as long as being light enough to be blown up by air, such as metal foil or the like.

The case body 12 is a virtually cylindrical transparent hollow case having space S to reproduce a state of snowfall of the imitation snow 14. Resin or glass may be used as material of the case body 12, but the material of the case body 12 is not particularly limited as long as the state of snowfall reproduced in the case body 12 can be seen from the outside of the case body 12. The case body 12 does not need to be wholly transparent. More specifically, the case body 12 may be transparent at least in a front face 31, that is, as far as the face in a direction the state of snowfall is seen is transparent, the other sides may be opaque.

The imitation snow lifting means 16 comprises: a tube-shaped member 20 provided in the case body 12; and a blower 24 for blowing air to a piping passage 21 in the tube-shaped member 20. The tube-shaped member 20 is centrally supported in a vertical position in the case body 12 by a bearing bar 26 so that an inlet 22 of the tube-shaped member 20 can be located in the lower portion of the case body 12 and an outlet 23 can be located in the upper portion of the case body 12. Further, the inlet 22 is secured to the upper portion of a spout 28 arranged at the bottom of the case body 12 in a floating state. The blower 24 is arranged below the spout 28 so that air can be blown from the spout 28 to the piping passage 21 by the rotation of a fan 30.

The cover 18 is a cover to be attached with at least outer circumference 32 of front face of the case body 12 covered. In addition to inability of seeing at least the outer circumference 32 of front face of the case body 12 when the indoor and outdoor decorative device 10 is seen from the front, the cover 18 has the decorative effect of the case body 12. In one embodiment of the present invention, a wreath is used as a cover and covers the entire side including the outer circumference 32 of front face of the case body 12 and the blower 24.

The indoor and outdoor decorative device 10 having such configuration ventilates from the spout 28 into the case body 12 by bringing the blower 24 into operation at first. On the other hand, the imitation snow 14 put into the case body 12 is collected on a reticulated member 34 provided at the spout 28 and is blown up upward in the piping passage 21 by wind fed into the piping passage 21 in the tube-shaped member 20 from the spout 28, and then is spouted into the case body 12 from the outlet 23 of the tube-shaped member 20. The spouted imitation snow 14 hits on the case body 12 located above the outlet 23 to be dispersed into the case body 12, which leads to reproduce the state of snowfall by dropping the imitation snow 14 in the case body 12. Most of the imitation snow 14 dropped in the case body 12 rolls toward the spout 28 in the inner circumference face of the case body 12. A portion of the imitation snow 14, which rolls along the inner side of the front face 31 and a back face 33, rolls on a tilted plate 36 placed obliquely downward toward the spout 28 from each of the front face 31 side and the back face 33 side and is eventually collected again on the reticulated member 34 provided at the spout 28. The imitation snow 14 collected again on the reticulated member 34 is blown up again upward in the piping passage 21 by ventilation from the spout 28 to be spouted from the outlet 23. Thus, the circulation of the imitation snow 14 in the case body 12 enables to continuously reproduce the state of snowfall in the case body 12.

As well as continuously reproducing the state of snow-fall in the case body 12, the indoor and outdoor decorative device 10 according to the present invention is capable of reducing the presence of the case body 12 because the cover 18 is attached to cover the outer circumference 32 of front face of the case body 12, which prevents the indoor space from being directly divided by the circumference of the case body 12. Accordingly, the indoor and outdoor decorative device 10 for reproducing the state of snowfall does not provide the indoor space with the feeling of pressure and the presence more than necessary.

The indoor and outdoor decorative device 10 according to the present invention does not need to secure mounting space for the device itself because of being a wall hanging type so as to be hung to an indoor wall surface or a door or a window by arranging fittings (not shown in figures) on the back face 33 of the indoor and outdoor decorative device 10, alternatively so as to be hung to hooks or the like previously arranged on the indoor wall surface.

Further, the indoor and outdoor decorative device 10 according to the present invention is capable of increasing the decoration effect of the indoor and outdoor by the additional function to reproduce the state of snowfall in a wall-hanging decoration, such as a conventional Christmas wreath or the like.

Furthermore, in FIG. 1 (c), the periphery part at the back face side of the indoor and outdoor decorative device is hidden by attaching the cover 18 so that outer circumference 38 of back face of the case body 12 can be covered as well as the outer circumference 32 of front face of the case body 12, which leads to remove the presence of the case body 12 even when seen from the back face side. For example, when the indoor and outdoor decorative device 10 is attached to the window glass from the indoor, the state of snowfall reproduced by the indoor and outdoor decorative device 10 is visible not only from the indoor but also from the outdoor, so that the indoor and outdoor decorative device 10 may be preferably used for a show window or the like as a display for store.

The tube-shaped member 20 of the present invention may be transparent or opaque. However, as well as reproducing the state of snowfall in the case body 12, a columnar substance caused by the lift of the imitation snow 14 in the central portion in the case body 12 is represented when the tube-shaped member 20 is transparent. More specifically, the arranging of imitation branches on the circumference face of the tube-shaped member 20 enables to represent the tube-shaped member 20 like a tree filled with snow.

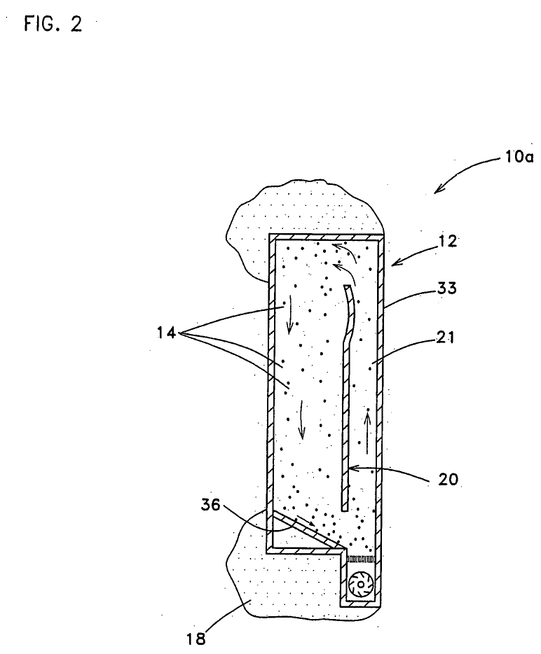

The position of the tube-shaped member 20 is not limited to the central portion shown in FIGS. 1 (a) to 1 (c). For example, as shown in FIG. 2, in an indoor and outdoor decorative device 10a, the tube-shaped member 20 may be in contact with the back face 33 side of the case body 12. In one embodiment of the present invention, since the tube-shaped member 20 can be directly secured to the back face 33 side in the case body 12, unlike the indoor and outdoor decorative device 10 shown in FIG. 1 (b), it is not necessary to support and secure the tube-shaped member 20 with a bearing bar 26. In addition, the state of snow-fall with depth can be reproduced by widely using inside the case body 12. Making the tube-shaped member 20 less noticeable is possible by coloring the case body 12 and the tube-shaped member 20 in the same color.

As mentioned above, the indoor and outdoor decorative devices 10 and 10a according to the present invention have thus been described in detail, but the indoor and outdoor decorative device of the present invention is not limited to the above-mentioned embodiments and may be realized in another embodiment.

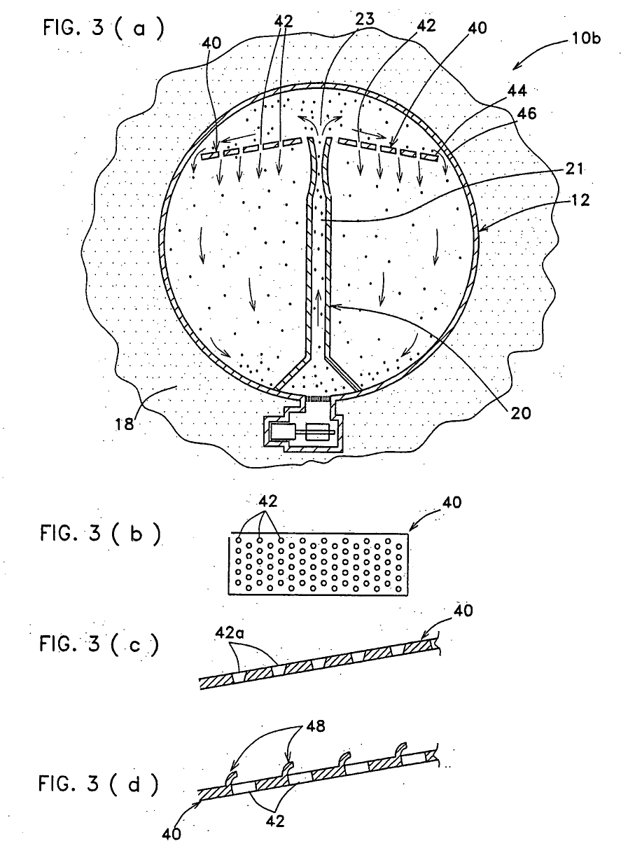

An indoor and outdoor decorative device 10b shown in FIG. 3 (a) basically has the similar configuration to the indoor and outdoor decorative device 10 shown in FIGS. 1 (a) to 1 (c), but has guide plates 40 in the upper portion of the case body 12 adjacent to the outlet 23 of the tube-shaped member 20. The guide plates 40 are plate-like members (FIG. 3 (b)) having a plurality of holes 42 where the imitation snow 14 can pass through and are obliquely provided in an obliquely downward direction from the outlet 23 toward the circumference of the case body 12. That is, the imitation snow 14 can be forced to disperse by temporally collecting the spouted imitation snow 14 with the guide plates 40 and sequentially dropping the imitation snow 14 downward from the holes 42 while rolling on the guide plates 40 when dropping the imitation snow 14 blown up upward in the piping passage 21 of the case body 12 by spouting from the outlet 23 into the case body 12. Accordingly, the state of snowfall can be more equally reproduced in the case body 12.

A method for installing the guide plates 40 is not particularly limited and the guide plates 40 may be secured to the front face 31 and/or the back face 33 in the case body 12. Alternatively, the guide plates 40 may be provides in a state of being apart from the inner surface of the case body 12 by supporting the guide plates 40 with the bearing bar 26. However, clearance 46 is needed between at least a downward edge 44 and the case body 12 to prevent the imitation snow 14 that has rolled on the guide plates 40 from being stored between the downward edge 44 of the guide plates 40 and the case body 12. The shape of the holes 42 of the guide plates 40 is not particularly limited. For example, like holes 42a shown in FIG. 3 (c), it is possible to aggressively lead the imitation snow 14 that rolls on the guide plates 40 to the holes 42a by the enlargement of the diameter of the upper surface side of the guide plates 40. Moreover, as shown in FIG. 3 (d), it is also possible to aggressively lead the imitation snow 14 that rolls on the guide plates 40 to the holes 42 by providing protrusions 48 on the downstream side of the holes 42 on the upper surface of the guide plates 40.

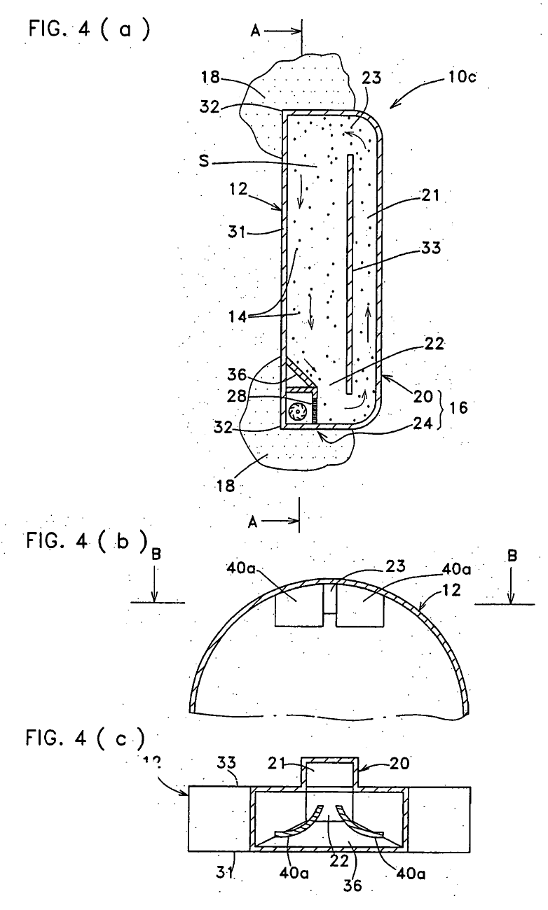

Another embodiments of the indoor and outdoor decorative device according to the present invention are shown in FIGS. 4 (a) to 4 (c). An indoor and outdoor decorative device 10c shown in FIGS. 4 (a) to 4 (c) also comprises: the case body 12; the imitation snow 14 put into the case body 12; the imitation snow lifting means 16 which comprises the tube-shaped member 20 and the blower 24; and the attached cover 18 covering the outer circumference 32 of front face of the case body 12. The tube-shaped member 20 of the present embodiment is vertically provided in the central portion of the back face 33 side of the case body 12. The inlet 22 of the tube-shaped member 20 is located at the bottom of the case body 12 and the outlet 23 is located at the top of the back face 33 of the case body 12. Two guide plates 40a adjacent to the outlet 23 respectively warped from the back face 33 toward the front face 31 of the case body 12 in the left and right directions of the case body 12 are provided.

In the indoor and outdoor decorative device 10c having such configuration, the imitation snow 14 fed into the case body 12 is collected from the inlet 22 of the tube-shaped member 20 positioned at the bottom of the case body 12 to the lower side in the piping passage 21 of the tube-shaped member 20. The imitation snow 14 is blown up from the lower portion to the upper portion of the piping passage 21 by sending air from the spout 28 formed in the piping passage 21 into the tube-shaped member 20 when bringing the blower 24 into operation. The blown up imitation snow 14 is spouted from the outlet 23 of the tube-shaped member 20 into the case body 12. Further, the spouted imitation snow 14 partially hits against the inner side of the front face 31 of the case body 12 at the outlet 23 to fall in the case body 12 and the remaining imitation snow 14 is forced to scatter in the left and right direction in the case body 12 by the guide plates 40a and then falls in the case body 12. The imitation snow 14 dropped in the case body 12 mostly rolls on the inner circumference face of the case body 12 toward the inlet 22. A part of the imitation snow 14 dropped along the inner side of the front face 31 of the case body 12 rolls on a tilted plate 36 obliquely downward disposed from the inner side of the front face 31 toward the spout 28 to eventually recollect downward in the piping passage 21. And then the imitation snow 14 recollected downward in the piping passage 21 is blown up again upward in the piping passage 21 by air sending from the spout 28 to be spouted from the outlet 23. Thus, the state of snowfall is continuously reproduced in the case body 12 by the circulation of the imitation snow 14 in the case body 12.

The indoor and outdoor decorative device 10c according to the present invention is capable of more widely securing space S to reproduce the state of snowfall using the imitation snow 14 by providing the tube-shaped member 20 at the back face 33 side of the case body 12 as well as continuous reproduction of the state of snowfall in the case body 12.

The back face 33 of the case body 12 and the tube-shaped member 20 according to the present invention may be transparent or opaque. However, the tube-shaped member 20 becomes invisible from the front face 31 of the indoor and outdoor decorative device 10c by making the back face 33 opaque.

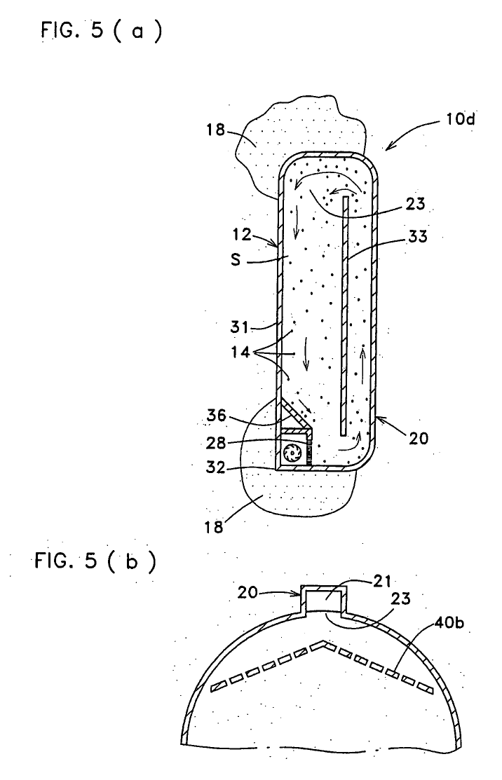

The position of the outlet 23 of the tube-shaped member 20 according to the present invention is not limited to the back-face 33 side of the case body 12, but as shown in an indoor and outdoor decorative device 10d in FIG. 5 (a), the outlet 23 may be located at the top of the case body 12. However, in this embodiment, guide plates 40b are preferably placed adjacent to the outlet 23 because the imitation snow 14 is spouted from the upper portion to just below the case body 12. The guide plates 40b are plate members (FIG. 5 (b)) in the shape of slanting from the central portion toward both ends having a plurality of holes 42 where the imitation snow 14 can pass through and are obliquely downward placed in the left and right direction toward the circumference of the case body 12 from just below the outlet 23. More specifically, the imitation snow 14 can be forced to disperse by temporally receiving the spouted imitation snow 14 on the guide plates 40b and sequentially dropping the imitation snow 14 downwardly from the holes 42 while rolling on the guide plates 40b when dropping the imitation snow 14 blown up upward in the piping passage 21 in the case body 12 by spouting from the outlet 23 into the case body 12. Accordingly, the state of snowfall can be more equally reproduced in the case body 12. Since the guide plates 40b have also the effect of shielding wind blowing off from the outlet 23, the guide plates 40b minimize the effect of wind on the imitation snow 14 falling in the case body 12.

The cross-sectional shape of the guide plates 40b is not limited to the shape of slanting toward both ends from the central portion and may be guide plates respectively having an arc cross-sectional shape. Embodiments shown in FIGS. 3 (c) and 3 (d) may be used as embodiments of the holes 42 made in the guide plates 40b.

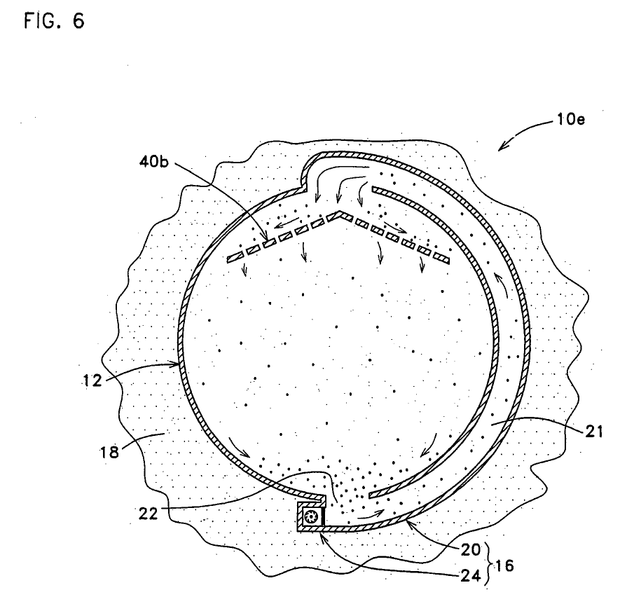

As mentioned above, while various embodiments of the present invention have thus been described with reference to the drawings, the tube-shaped member 20 of the indoor and outdoor decorative device according to the present invention is not limited to the embodiment of being vertically attached to the case body 12. For example, like an indoor and outdoor decorative device 10e shown in FIG. 6, the tube-shaped member 20 of the imitation snow lifting means 16 may be provided along the outer circumference of side of the virtually cylindrical case body 12. Attaching the tube-shaped member 20 to the case body 12 prevents the tube-shaped member 20 from extruding to the front face 31 and the back face 33 side of the case body 12. Further, the cover 18, such as a wreath, can easily cover the outer circumference of the case body 12 including the imitation snow lifting means 16.

The shape of the case body 12 is not limited to a virtually cylindrical shape, either. The shape of a sectional form seen from the front may be either an oval, or a polygon and the like. The cover 18 is not limited to a wreath. Various embodiments of the cover 18 may be used in accordance with the shape of the case body 12 and the atmosphere in the room space where the indoor and outdoor decorative device is decorated.

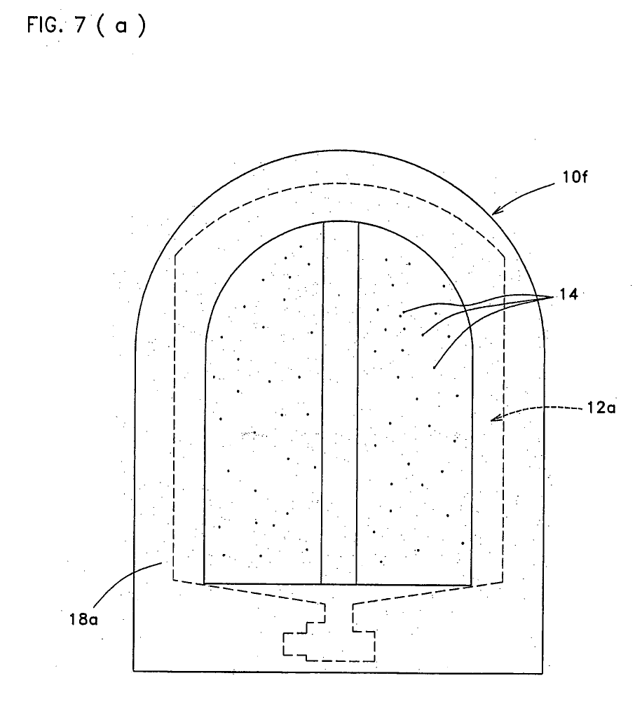

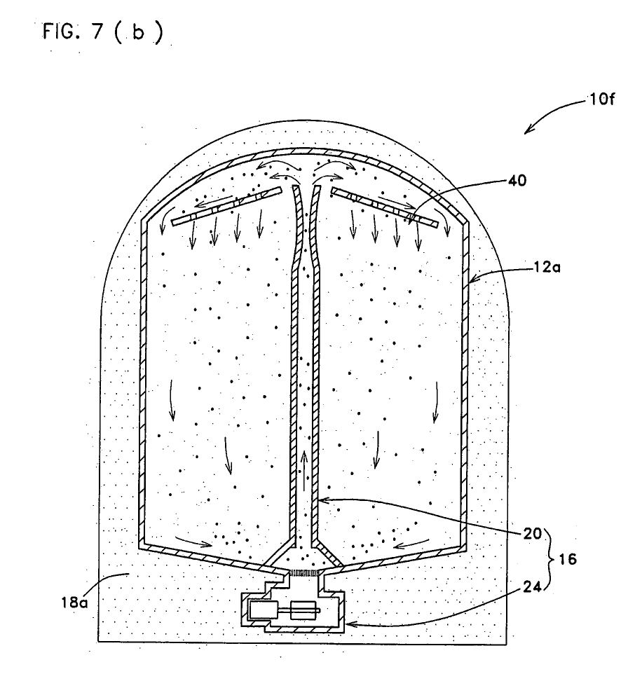

For example, in an indoor and outdoor decorative device 10f shown in FIG. 7 (a), a cover 18a imitating a window frame is provided to a case body 12a which is hollow. As shown in FIG. 7 (b), the case body 12a is virtually rectangular and its top face has a shape warped in a protruding condition. More specifically, in the shape and the mode of the case body 12a and the cover 18a, the shape and the mode of one of them may be arbitrarily adopted in conformity with those of another. In the embodiment shown in FIGS. 7 (a) and 7 (b), the creating effect, in which an imitation window can be seen on the wall, can be exerted by decorating an indoor and outdoor decorative device 10f on the indoor wall face. In addition, the drawing and printing scenery on the back side in the case body 12a enables to reproduce the state of snowfall in the scene outside the window seen from the imitation window (indoor and outdoor decorative device 10f).

In the indoor and outdoor decorative device 10f, the tube-shaped member 20 provided in the central portion of the case body 12a is covered with a portion of the cover 18a which is an imitation window frame, so that the tube-shaped member 20 is invisible from the front face of the indoor and outdoor decorative device 10f. However, a cover imitating a window frame without sash bar (imitation window frame) can be used by providing the tube-shaped member 20 in the modes like the above-mentioned indoor and outdoor decorative devices 10c to 10e.

In the indoor and outdoor decorative device of the present invention that has been described so far, while the imitation snow lifting means of each embodiment unexceptionally comprises a tube-shaped member and a blower, the imitation snow lifting means of the present invention is not limited to such embodiment and another configuration is also possible.

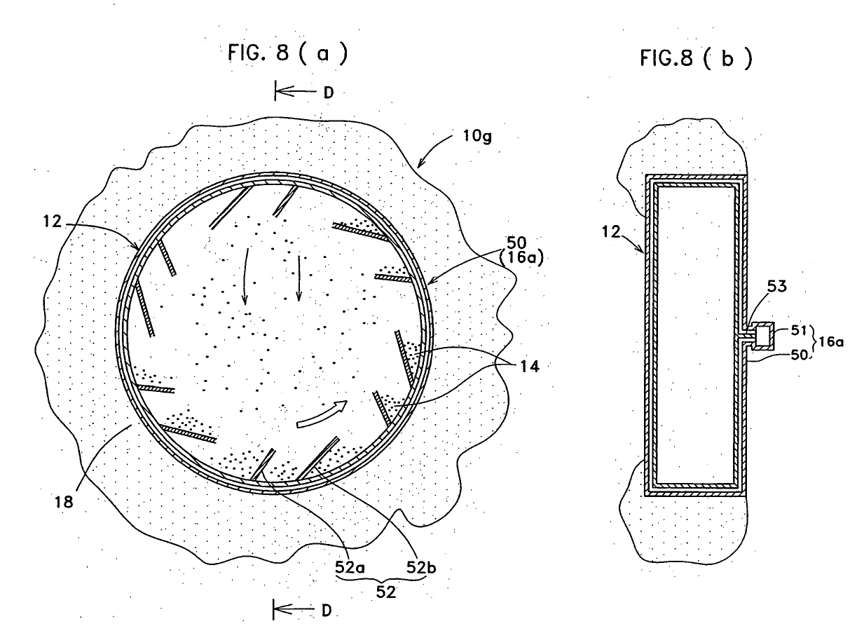

For example, an indoor and outdoor decorative device 10g shown in FIG. 8 (a) comprises: a case body 12 which is hollow and virtually tube-shaped; an imitation snow lifting means 16a; and a cover 18 attached to the case body 12.

The imitation snow lifting means 16a comprises: a rotary wheel 50 rotatably provided in the case body 12; and a motor 51, such as an electric motor to rotate and drive the rotary wheel 50. The rotary wheel 50 is a hollow tube-shaped which is virtually the same as that of the case body 12. A plurality of backing plates 52 for imitation snow are spaced around the inner circumference of its side face (circumference portion) tilted in a rotation direction from a rotation axis 53 located in the center of the rotary wheel 50. Further, the backing plates 52 for imitation snow of the present invention respectively have an oblique angle which is different from adjacent backing plates 52 for imitation snow.

In the indoor and outdoor decorative device 10g having such imitation snow lifting means 16a, the imitation snow 14 is fed into the rotary wheel 50 provided in the case body 12 to be collected at the lower portion of the rotary wheel 50. When the rotation axis 53 extruding on the back face of the rotary wheel 50 is rotated by an electric motor (motor 51), the imitation snow 14 collected in the lower portion of the rotary wheel 50 is sequentially carried above the rotary wheel 50, that is, the imitation snow 14 is carried upwardly in the case body 12 by the backing plates 52 for imitation snow. In this imitation snow 14, the imitation snow 14 carried upwardly by the backing plates 52a for imitation snow respectively having an large oblique angle firstly starts dropping and as the rotary wheel 50 rotates, the imitation snow 14 carried by backing plates 52b for imitation snow respectively having a small oblique angle also starts dropping. The dropped imitation snow 14 is collected in the lower portion of the rotary wheel 50 again to be carried again to the upper side of the case body 12 by the backing plates 52 for imitation snow. The state of snowfall is continuously reproduced in the rotary wheel 50 of the case body 12 in such a manner that the imitation snow 14 is circulated by the rotary wheel 50 in the case body 12.

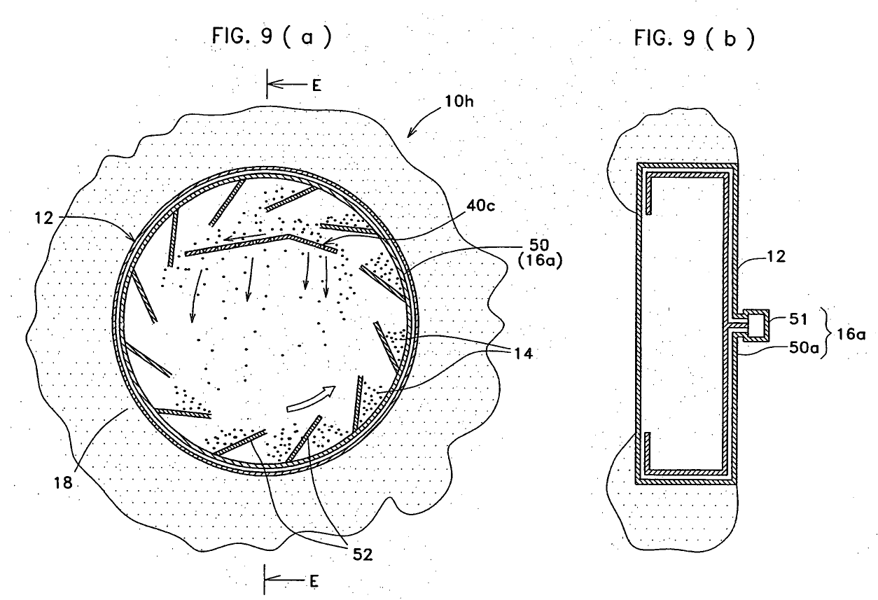

There may be another embodiment such as an indoor and outdoor decorative device 10h having the imitation snow lifting means 16a shown in FIG. 9. In the indoor and outdoor decorative device 10h, oblique angles of respective backing plates 52 for imitation snow are identical. Further, in the indoor and outdoor decorative device 10h, a guide plate 40c for scattering the imitation snow 14 dropping from the backing plates 52 for imitation snow into the case body 12 is provided upward in the case body 12. A plurality of holes 42 are formed on the guide plate 40c and the state of snowfall is reproduced by sequentially dropping the imitation snow 14 dropped from the backing plates 52 for imitation snow into the case body 12 from the holes 42 while rolling on the tilted guide plate 40c. Since the guide plate 40c needs to be secured in the case body 12, as shown in FIG. 9 (b), there is no possibility of a rotary wheel 50a hitting against the guide plate 40c provided inside the front face 31 in the case body 12 because the rotary wheel 50a provided in the case body 12 is C-shaped or groove-shaped in its cross section.

Methods for rotating and driving the rotary wheels 50 and 50a of the imitation snow lifting means 16a are not limited to the above-mentioned embodiments, but may be another embodiment in which a gear is formed on the outer circumference of the rotary wheel to rotate the rotary wheel by the rotation of a pinion using an electric motor.

It should be understood that the embodiments of the indoor and outdoor decorative device according to the present invention that have been described above do not virtually limit technical ideas of the present invention. For example, a plurality of light-emitting diodes and a tip of glass fiber may be arranged on the back face side of the case body of the present invention. The state of snowfall in the night sky where stars are twinkling can be reproduced in the case body 12 by shining the plurality of light-emitting diodes and the tip of glass fiber.

Additionally, the indoor and outdoor decorative device of the present invention may be equipped with a lighting apparatus to illuminate the case body.

While the embodiments of the present invention have thus been described with reference to the drawings, it should be understood that the present invention be not limited to the embodiments shown in the drawings. Various changes, modifications, and improvements can be made to the embodiments on the basis of knowledge of those skilled in the art without departing from the scope of the present invention.

This application is based on Japanese Utility Model Application No. 2005-008913, which is incorporated herein by reference into the United States application.

What is claimed is:

1. An indoor and outdoor decorative device comprising:
a case body which is hollow at least whose front face is transparent;
imitation snow lifting means for lifting the imitation snow from the lower portion to the upper portion of the case body and dropping the imitation snow in the case body; and
a cover to be attached to the case body,
wherein at least the outer circumference of front face of the case body is covered with the cover.

2. The device according to claim 1, wherein the imitation snow lifting means comprises:
a tube-shaped member in which an inlet is located in the lower portion of the case body and an outlet is located in the upper portion of the case body; and
a blower for blowing the imitation snow from the inlet to the outlet in a piping passage within the tube-shaped member to spout the imitation snow from the outlet into the case body,
wherein the blower or the imitation snow lifting means is covered with the cover.

3. The device according to claim 2, wherein the tube-shaped member is provided outside the case body and there is continuity between the inside of the case body and a piping passage by the inlet and the outlet.

4. The device according to claim 1, wherein a guide plate for dispersing the imitation snow to be spouted from the outlet into the case body is provided in the case body adjacent to the outlet.

5. The device according to claim 2, wherein a guide plate for dispersing the imitation snow to be spouted from the outlet into the case body is provided in the case body adjacent to the outlet.

6. The device according to claim 3, wherein a guide plate for dispersing the imitation snow to be spouted from the outlet into the case body is provided in the case body adjacent to the outlet.

7. The device according to claim 1, wherein the imitation snow lifting means comprises:
a rotary wheel rotatably arranged in the case body; and
a motor for rotating and driving the rotary wheel, wherein a plurality of backing plates for imitation snow tilted from an rotation axis located in center of the rotary wheel toward the direction of rotation are spaced around the circumference of the rotary wheel and the imitation snow is lifted from the lower portion to the upper portion of the case body by the backing plates for imitation snow.

8. The device according to claim 7, wherein the backing plates respectively have a different oblique angle.

9. The device according to claim 7, wherein a guide plate for dispersing the imitation snow falling from the backing plates for imitation snow into the case body is provided in the upper portion of the case body.

10. The device according to claim 8, wherein a guide plate for dispersing the imitation snow falling from the backing plates for imitation snow into the case body is provided in the upper portion of the case body.
